(19) United States
(12) Patent Application Publication
(10) Pub. No.: US 2015/0013814 A1
(43) Pub. Date: Jan. 15, 2015

(54) SEALED FILL CAP ASSEMBLY

(71) Applicant: GM Global Technology Operations LLC, Detroit, MI (US)

(72) Inventors: CHRISTOPHER B. PRESTON, TROY, MI (US); CHRISTINE A. BLAKE, ROYAL OAK, MI (US)

(73) Assignee: GM Global Technology Operations LLC, Detroit, MI (US)

(21) Appl. No.: 14/152,593

(22) Filed: Jan. 10, 2014

Related U.S. Application Data
(60) Provisional application No. 61/845,033, filed on Jul. 11, 2013.

(51) Int. Cl. F16H 57/027; F15B 1/12

(52) U.S. Cl. CPC F16H 57/027; F15B 1/12
USPC 138/30

(57) ABSTRACT

A fill cap assembly for a transmission is provided. In one form, the fill cap assembly includes a first part and a second part, each defining a cavity therein. A flexible membrane is disposed between the first and second parts and separates the cavities of the first and second parts. The cavities are sealed from each other by the membrane. The cavity of the first part is configured to be in fluid communication with the inside of the transmission. When pressure rises in the transmission, the flexible membrane expands into the cavity of the second part. When pressure sinks in the transmission, the membrane collapses partially into the cavity of the first part, thus expanding out of and/or away from the cavity of the second part.

### CROSS-REFERENCE TO RELATED APPLICATIONS

This application claims the benefit of U.S. Provisional Application No. 61/845,033, filed on Jul. 11, 2013, which is herein incorporated by reference in its entirety.

### FIELD

The present disclosure relates to devices for venting automatic transmissions, and more specifically, to a vent cap or fill cap assembly for an automotive transmission that allows for pressure fluctuations in the transmission.

### BACKGROUND

The statements in this section merely provide background information related to the present disclosure and may or may not constitute prior art.

A transmission, particularly a hydraulically controlled planetary gear automatic transmission for a motor vehicle, operates at temperatures well above ambient, often at 130° C. (265° F.) or higher. Because the transmission may begin operation at ambient temperatures as low as −35° C. (−30° F.) or lower, the air within the transmission will undergo significant expansion. Conversely, when the transmission becomes inactive, the transmission's nominal temperature may drop relatively rapidly and the air within the transmission will contract. In order to accommodate these changes and to avoid pressurization or a partial vacuum within the transmission, a transmission is equipped with a breather system which allows exhaust and ingestion of air.

The vent cap openings, however, may allow the intrusion of debris and liquid, such as water, into the transmission, which may be undesirable. Certain arrangements of transmission vent caps include a mesh positioned over the opening to prevent debris from entering the housing, but these meshes do not keep liquid from intruding into the transmission. Accordingly, there is a need for a cover that allows pressure fluctuations and heat to vent from the transmission, without allowing liquid or debris to enter into the transmission.

### SUMMARY

The present disclosure provides a fill cap, or vent cap, for a transmission assembly that prevents debris and moisture from entering the transmission, but also compensates for and allows for pressure fluctuations within the transmission.

In one aspect, which may be combined with or separate from the other aspects described herein, a vent cap or fill cap assembly for a transmission is provided that includes a rigid base and a flexible membrane. The flexible membrane is sealed against the base such that no liquid or debris can enter or exit the base through or adjacent to the membrane. The base may have an inner cavity that is in fluid communication with the inside of a transmission assembly. If pressure rises within the transmission, the flexible membrane is configured to fluctuate and expand in an outward direction from the base; and if pressure sinks within the transmission, the flexible membrane is configured to compress or collapse toward the in base and into the cavity of the base.

In another aspect, which may be combined with or separate from the other aspects described herein, the fill cap assembly includes rigid lower and upper parts, which may be shaped as half spheres, cylinders, boxes, or any other suitable shape. A flexible membrane is disposed between the lower part and the upper part. The lower and upper parts each define a cavity disposed on a side of the membrane. The upper and lower cavities are sealed from each other by the flexible membrane. The cavity of the lower part is in communication with the inside of the transmission. When pressure rises in the transmission, the flexible membrane expands into the cavity of the upper part. When pressure sinks in the transmission, the flexible membrane collapses partially into the cavity of the lower party, thus expanding away from the cavity of the upper part.

In yet another aspect, which may be combined with or separate from the other aspects described herein, a fill cap assembly for a vehicular transmission is provided. The fill cap assembly includes a fill part forming a cavity therein, the fill part having a fill part edge. A channel portion forms a channel in the fill part. The channel is configured to fluidly connect the cavity of the fill part to an inner space within the vehicular transmission. A flexible membrane is disposed adjacent to the fill part edge. The flexible membrane is connected to the fill part edge to form a seal along the fill part edge. The flexible membrane is configured to expand when pressure rises within the cavity.

In still another aspect, which may be combined with or separate from other aspects described herein, a fill cap assembly for a vehicular transmission is provided. The fill cap assembly includes a flexible membrane configured to contract and expand, a structure connected to the flexible membrane, and a channel portion. The structure and the flexible membrane cooperate to form a cavity therebetween. The channel portion forms a channel therein. The channel is configured to fluidly connect the cavity to an inner space within the vehicular transmission. The cavity is fluidly sealed except for the channel that communicates with the cavity.

In still another aspect, which may be combined with or separate from the other aspects described herein, a fill cap assembly for a vehicular transmission is provided. The fill cap assembly includes a first sphere half forming a first cavity therein. The first sphere half defines a round first edge. A projection extends from a side wall of the first sphere half, and the projection defines a channel therein. The channel is in fluid communication with the first cavity, and the channel being configured to fluidly connect the first cavity to an inner space within the vehicular transmission. A second sphere half forms a second cavity therein, and the second sphere half defines a round second edge. The round second edge is connected to the round first edge. An elastomeric membrane is disposed between the first and second sphere halves adjacent to the first and second round edges. The elastomeric membrane forms a seal between the first and second cavities, and the first and second cavities are not in fluid communication with each other. The elastomeric membrane is configured to expand when pressure rises within the first cavity.

Further aspects, advantages and areas of applicability will become apparent from the description provided herein. It should be understood that the description and specific examples are intended for purposes of illustration only and are not intended to limit the scope of the present disclosure.

### DRAWINGS

The drawings described herein are for illustration purposes only and are not intended to limit the scope of the present disclosure in any way.

FIG. 1A is a perspective view of a portion of a motor vehicle including a transmission and a fill cap assembly, according to the principles of the present disclosure;

FIG. 1B is a perspective view of the fill cap assembly of FIG. 1A attached to a vehicle structure, in accordance with the principles of the present disclosure;

FIG. 1C is a partially exploded perspective view of the fill cap assembly of FIGS. 1A-1B, according to the principles of the present disclosure;

FIG. 1D is a side schematic cross-sectional view of the fill cap assembly of FIGS. 1A-1C, showing the fill cap assembly in an unexpanded configuration, in accordance with the principles of the present disclosure;

FIG. 1E is a side schematic cross-sectional view of the fill cap assembly of FIGS. 1A-1D, showing the fill cap assembly in an expanded configuration, according to the principles of the present disclosure;

FIG. 1F is a side schematic cross-sectional view of the fill cap assembly of FIGS. 1A-1E, showing the fill cap assembly in a collapsed configuration, in accordance with the principles of the present disclosure; and

FIG. 2 is a side schematic cross-sectional view of another fill cap assembly in accordance with the principles of the present disclosure.

### DETAILED DESCRIPTION

The following description is merely exemplary in nature and is not intended to limit the present disclosure, application, or uses.

With reference to the figures, a transmission assembly is illustrated and generally designated at 10. The transmission assembly 10 is installed within a motor vehicle. The transmission assembly 10 includes an automotive transmission 14 and a fill cap assembly 16 (or vent cap assembly).

The transmission assembly 10 is attached to vehicle structure 12. For example, the transmission 14 is bolted to the vehicle structure 12, and the fill cap assembly 16 is also attached by bolts 17 to a vehicle shock tower 18, which is also attached to vehicle structure 12.

The fill cap assembly 16 has a protrusion 20 extending from a lower part 22 of the fill cap assembly 16. The protrusion 20 is connected to a hose 24. The hose 24 extends from the fill cap assembly 16 to the transmission 14. Accordingly, the hose 24 fluidly connects a chamber or cavity inside the fill cap assembly 16 with the inside of the transmission 14, which will be described in further detail below. The hose 24 may be connected to the transmission 14 by another structure, such as a vent cap attachment 26 that has an opening fluidly connecting the hose 24 with the inside of the case of the transmission 14.

Accordingly, in the illustrated example, the fill cap assembly 16 is rigidly attached to the shock tower 18 instead of to the transmission 14, but it should be understood that the fill cap assembly 16 alternatively could be attached to any other suitable structure in the vehicle, such as to the top side of the case of the transmission 14 itself.

The fill cap assembly 16, along with a hose 24 attached thereto, allows the transmission 14 to “breathe,” for example, to allow air pressure to move into and out of the case of the transmission 14 through the hose 24, and specifically, through the hose 24 attached to the chamber of the lower part 22 of the fill cap assembly 16. In other words, the fill cap assembly 16 allows for pressure fluctuation due to temperature variation but prevents debris and moisture from entering into the transmission 14.

In the illustrated example, the fill cap assembly 16 includes a lower sphere half part 22 and an upper sphere half part 28. A pressure blow-off valve 30 is disposed at the top of the upper part 28. A weld joint 32, or other joint, joins the upper part 28 to the lower part 22, thus creating a rigid base made of the upper and lower parts 28, 22.

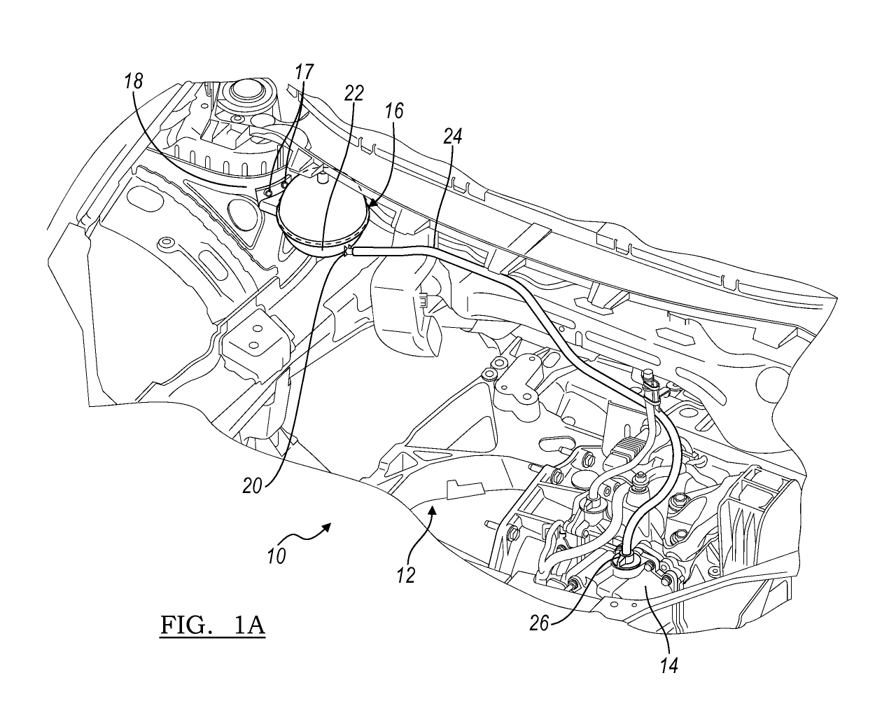

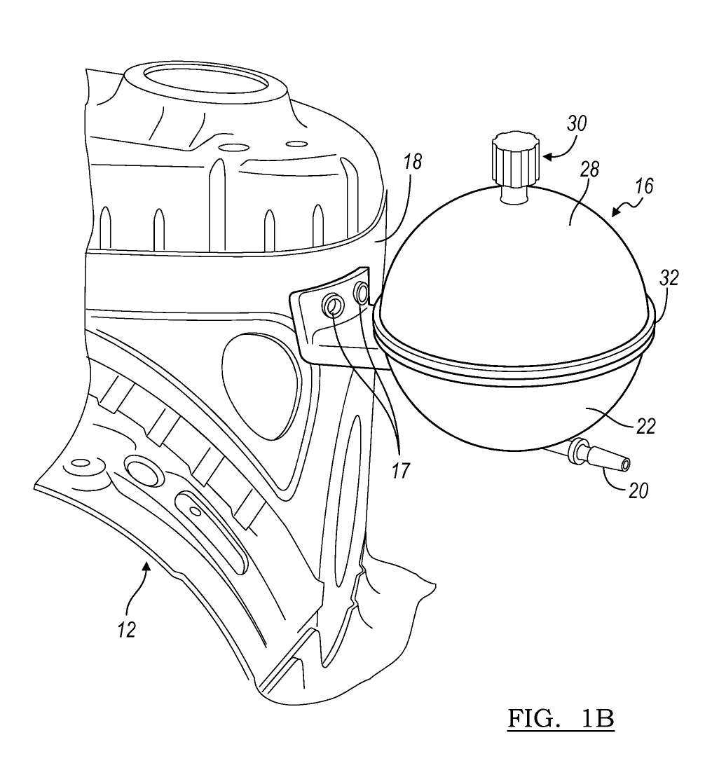

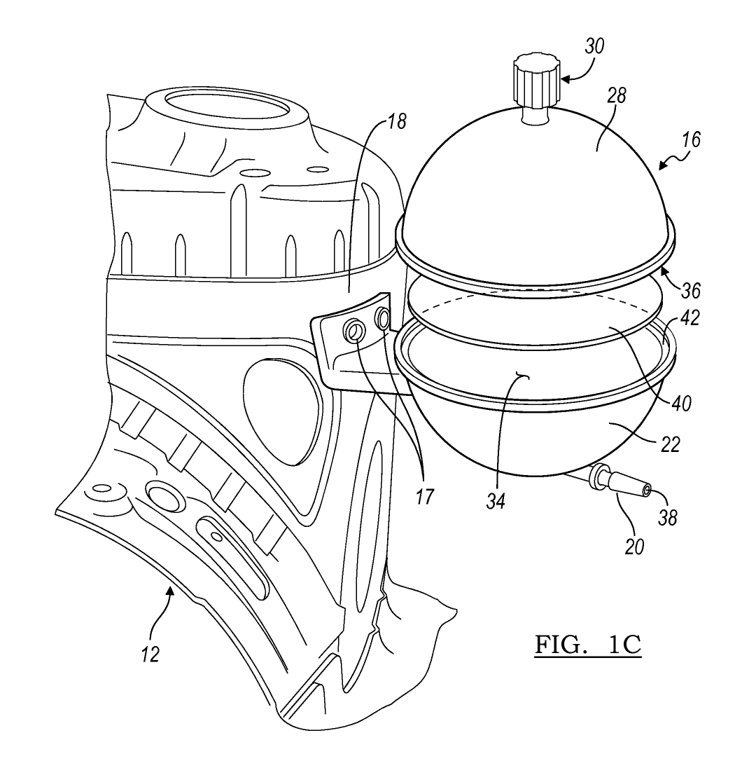

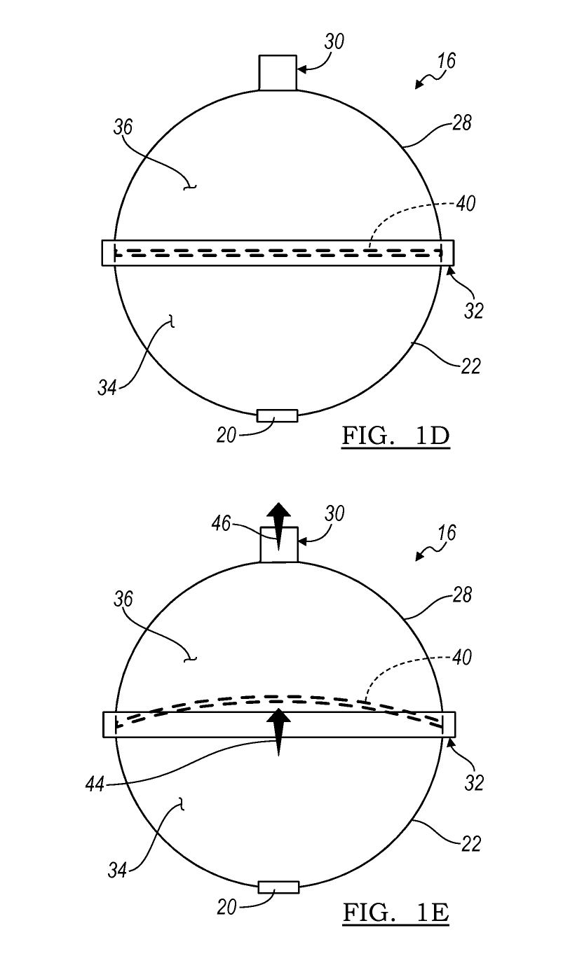

Referring now to FIG. 1C, the fill cap assembly 16 is shown in a partially exploded view, showing the inner contents of the fill cap assembly 16. Each of the lower and upper parts 22, 28 is hollow and has an inner cavity; thus, the lower half-spherical part 22 defines a lower inner cavity 34 and the upper half-spherical part defines an upper inner cavity 36. The upper inner cavity 36 communicates with the blow-off valve 30, which may be a one-way valve. The lower inner cavity 34 is in communication with a channel 38 in the protrusion 20. Therefore, when the hose 24 is connected to the protrusion 20, the hose 24 fluidly connects the lower inner cavity 34 with the inside of the transmission 14.

A flexible membrane 40 is disposed between the lower and upper cavities 34, 36 of the lower and upper parts 22, 28. The flexible membrane 40 may be fixed into place between the lower and upper parts 22, 28 when the parts 22, 28 are connected together by the weld joint 32 or in any other suitable manner. In the illustrated example, the flexible membrane 40 rests on a lip 42 of the lower part 22, which follows the circumference of the edge of the lower part 22. The flexible membrane 40 is clamped into place between the lower and upper parts 22, 28 when the parts 22, 28 are joined by the weld joint 32 or another joint. The flexible membrane 40 separates the upper cavity 36 from the lower cavity 34 such that the cavities 36, 34 are not in fluid communication with each other. In the illustrated example, the flexible membrane 40 is a flat disc when in the unexpanded configuration.

The flexible membrane 40 may be formed of any suitable flexible material. In one example, the flexible membrane 40 is formed of an elastomeric material, such as synthetic or natural rubber. The upper and lower parts 28, 22 may also be formed of any suitable material, such as rubber or plastic, or a composite plastic. A composite plastic such as a glass-filled plastic is a suitable material that provides the fill cap assembly 16 with a desired light weight. Should the lower and upper parts 22, 28 be formed of a composite plastic, they could be sonic welded together to create the weld joint 32 and to clamp the flexible membrane 40 between the upper and lower parts 28, 22.

Referring now to FIG. 1D, the fill cap assembly 16 is illustrated in a schematic cross-sectional view, showing the membrane 40 disposed between the upper and lower sphere halves 28, 22 in an unexpanded position or configuration. In this position, there has been little or no pressure fluctuation in the transmission 14 from the pressure at which the fill cap assembly 16 was installed or the rest pressure of the transmission 14. (It should be understood that the unexpanded configuration of the flexible membrane 40 could be configured to be present at any desired pressure of the transmission 14). Accordingly, the flexible membrane 40 extends approximately flat and horizontally through the sphere halves 22, 28, resembling a flat, circular disc in the illustrated example.

Referring to FIG. 1E, a pressurized lower cavity 34 is illustrated. In FIG. 1E, the pressure in the transmission 14 has risen, typically due to a rising temperature. Therefore, the air in the transmission 14 has expanded and the greater air volume escapes the transmission 14 through the hose 24 and into the cavity 34 of the lower part 22. When the air volume in the lower cavity 34 expands, the flexible membrane 40 expands, or stretches, in an upward direction into the cavity 36 of the upper part 28, as illustrated by arrow 44. In other words, when the pressure builds in the cavity 34 of the lower part 22, the flexible membrane 40 expands in the upward direction 44.

The lower cavity 34 remains isolated from the upper cavity 36, such that no debris or moisture enters the lower cavity 34 from the upper cavity 36. When the flexible membrane 40 expands into the upper cavity 36 as shown in FIG. 1E, the air pressure in the upper cavity 36 increases, and if the air pressure exceeds a predetermined level, air pressure escapes through the blow-off valve 30, as illustrated schematically by arrow 46. For example, as the flexible membrane 40 compresses the air in the upper cavity 36 of the upper part 28, air is forced out of the upper cavity 36 through the blow-off valve 30.

The upper part 28 protects the flexible membrane 40 from damage, but in some variations, the upper part 28 could be eliminated and the flexible membrane 40 could merely be sealed to the lower part 22.

Referring now to FIG. 1F, the flexible membrane 40 is illustrated as being collapsed in a downward direction, as indicated by arrow 48, and partially into the lower cavity 34. The flexible membrane 40 collapses into the lower cavity 34 as illustrated when there is a predetermined level of a negative pressure within the transmission 14, such as when the transmission is cold or cools down. When the flexible membrane 40 collapses as illustrated in FIG. 1F, the blow-off valve 30 is sucked closed by the negative pressure, in the direction 50 as illustrated.

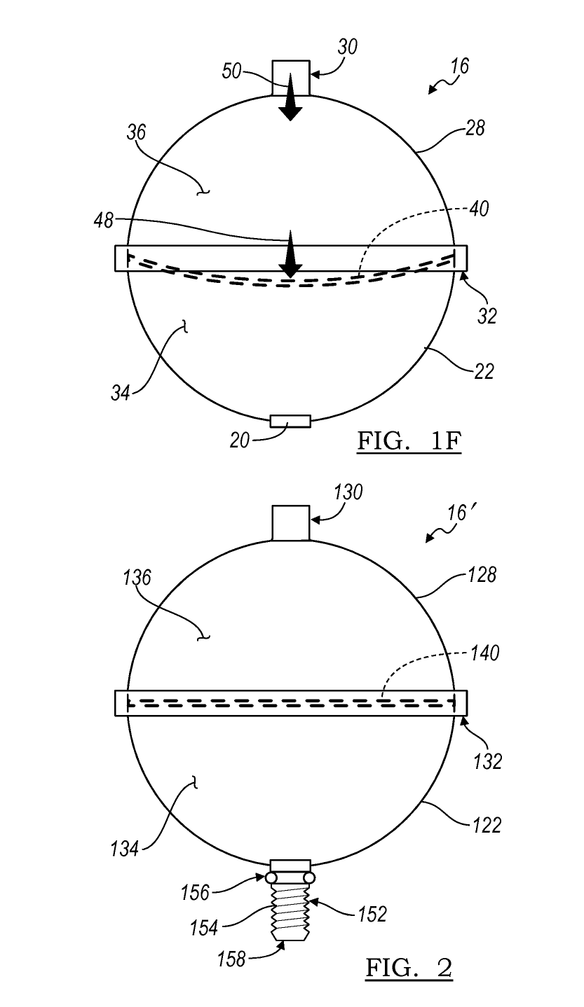

Referring now to FIG. 2, another variation of a fill cap assembly is illustrated and generally designated at 16′. Like the fill cap assembly 16 described above, the fill cap assembly 16′ in FIG. 2 includes upper and lower sphere halves or parts 128, 122 welded together at weld joint 132. A flexible membrane 140 is disposed between the upper and lower parts 128, 122 and separates upper and lower cavities 136, 134, as described above, and the upper cavity 136 communicates with a blow-off valve 130. The flexible membrane 140 is illustrated in an unexpanded configuration, as shown in FIG. 1D.

In the example in FIG. 2, the fill cap assembly 16′ includes a protrusion 152 extending from the lower part 122 that may be directly attached to a transmission, such as transmission 14. For example, in one variation, the protrusion 152 bears threads 154 that may be used to screw the protrusion 152, and thus the fill cap assembly 16′, to the transmission 14. Once the fill cap assembly 16′ is screwed into the transmission 14, an O-ring 156 assists in sealing the fill cap assembly 16′ against the case of the transmission 14 to avoid leaks. A channel 158 through the protrusion 152 fluidly connects the lower cavity 134 to the inside of the case of the transmission 14. Except for the differences described in this paragraph, the fill cap assembly 16′ may operate the same as the fill cap assembly 16 described above, or with any other variation described herein.

For example, the flexible membrane 40, 140 need not be a flat disc as illustrated. In one alternative embodiment, the flexible membrane 40, 140 could comprise bellows disposed between the upper and lower parts 28, 128, 22, 122, or the bellows could be located at the top of the lower part 22, 122 if the upper part 28, 128 is eliminated. In another variation, the lower and upper parts 22, 122, 28, 128 could have a shape other than a sphere shape; for example, the lower and upper parts 22, 122, 28, 128 could have a cylindrical, square, rectangular, or any other desired shape. The variation in shape of the lower and upper parts 22, 122, 28, 128 could also use the bellows variation of the flexible membrane 40, 140.

Thus, the present disclosure provides a sealed fill cap assembly 16, 16′ that allows for pressure fluctuation in the transmission 14, but prevents debris and moisture from entering into the case or other inside part of the transmission 14. The flexible membrane 40, 140 compensates for pressure fluctuations by expanding in an upward or downward direction.

The description of the invention, and certain embodiments of it, is merely exemplary in nature and variations that do not depart from the gist of the invention are intended to be within the scope of the invention. Such variations are not to be regarded as a departure from the spirit and scope of the invention.

What is claimed is:

1. A fill cap assembly for a vehicular transmission, the fill cap assembly comprising:
a fill part forming a cavity therein, the fill part having a fill part edge;
a channel portion forming a channel formed in the fill part, the channel configured to fluidly connect the cavity of the fill part to an inner space within the vehicular transmission; and
a flexible membrane disposed adjacent to the fill part edge, the flexible membrane being connected to the fill part edge to form a seal along the fill part edge, the flexible membrane being configured to expand when pressure rises within the cavity.

2. The fill cap assembly of claim 1, the fill part being a first fill part, the fill cap assembly further comprising a second fill part disposed adjacent to the flexible membrane.

3. The fill cap assembly of claim 2, wherein the flexible membrane has a first side and an opposite second side, the first side being attached to the first fill part, the second fill part being disposed adjacent to the second side.

4. The fill cap assembly of claim 3, the second fill part having a second edge that is sealed again the first fill part.

5. The fill cap assembly of claim 4, the cavity being a first cavity, the second fill part forming a second cavity therein, the second fill part further comprising a valve fluidly connecting the second cavity with outside ambient air.

6. The fill cap assembly of claim 5, wherein the flexible membrane separates the second cavity from the first cavity, the first and second cavities not fluidly communicating with each other.

7. The fill cap assembly of claim 6, wherein the flexible membrane expands into the second cavity when pressure rises within the first cavity, the valve of the second fill part allowing air to escape from the second cavity through the valve when the flexible membrane expands into the second cavity.

8. The fill cap assembly of claim 7, wherein the flexible membrane is configured to collapse into the first cavity when pressure within the second cavity exceeds pressure within the first cavity.

9. The fill cap assembly of claim 8, wherein the flexible membrane is formed of an elastomeric material.

10. The fill cap assembly of claim 9, wherein the valve is a one-way valve.

11. The fill cap assembly of claim 10, further comprising a projection extending from a side wall of the first fill part, the projection forming at least a portion of the channel therein, the projection being configured to be connected to a hose.

12. The fill cap assembly of claim 11, wherein the first fill part and the second fill part each form half of a hollow sphere.

13. The fill cap assembly of claim 12, the first and second fill parts being welded together along a circumference of the sphere.

14. A fill cap assembly for a vehicular transmission, the fill cap assembly comprising:
a flexible membrane configured to contract and expand;
a structure connected to the flexible membrane, the structure and the flexible membrane cooperating to form a cavity therebetween; and
a channel portion forming a channel therein, the channel being configured to fluidly connect the cavity to an inner space within the vehicular transmission, the cavity being fluidly sealed except for the channel that communicates with the cavity.

15. The fill cap assembly of claim 14, the flexible membrane being sealed against at least one edge of the structure to form the cavity.

16. The fill cap assembly of claim 15, the cavity being a first cavity, the structure being a first sphere half, the fill cap assembly further comprising a second sphere half attached to the first sphere half, the second sphere half forming a second cavity therein, the flexible cavity separating the first cavity from the second cavity.

17. The fill cap assembly of claim 16, wherein the first and second sphere halves are welded together and form a sphere.

18. The fill cap assembly of claim 17, the second sphere half comprising a valve fluidly connecting the second cavity with outside ambient air.

19. The fill cap assembly of claim 18, wherein the first and second cavities are not in fluid communication with each other, the flexible membrane being formed of an elastomeric material.

20. A fill cap assembly for a vehicular transmission, the fill cap assembly comprising:
a first sphere half forming a first cavity therein, the first sphere half defining a round first edge;
a projection extending from a side wall of the first sphere half, the projection defining a channel therein, the channel being in fluid communication with the first cavity, the channel being configured to fluidly connect the first cavity to an inner space within the vehicular transmission;
a second sphere half forming a second cavity therein, the second sphere half defining a round second edge, the round second edge being connected to the round first edge;
an elastomeric membrane disposed between the first and second sphere halves adjacent to the first and second round edges, the elastomeric membrane forming a seal between the first and second cavities, the first and second cavities not being in fluid communication with each other, the elastomeric membrane being configured to expand when pressure rises within the first cavity.
